(19) United States
(12) Patent Application Publication
(10) Pub. No.: US 2022/0315806 A1
(43) Pub. Date: Oct. 6, 2022

(54) MICRO-GROOVE DRAG REDUCTION FLEXIBLE FILM AND PREPARATION METHOD THEREOF

(71) Applicant: Zhejiang University, Hangzhou (CN)

(72) Inventors: Yao Zheng, Hangzhou (CN); Zhixian Ye, Hangzhou (CN); Jianfeng Zou, Hangzhou (CN); Yang Zhang, Hangzhou (CN); Yiyang Jiang, Hangzhou (CN); Zenan Tian, Hangzhou (CN); Shaochang Mo, Hangzhou (CN)

(73) Assignee: Zhejiang University, Hangzhou (CN)

(21) Appl. No.: 17/633,174

(22) PCT Filed: Aug. 18, 2020
(86) PCT No.: PCT/CN2020/109706

§ 371 Date: Feb. 4, 2022

(30) Foreign Application Priority Data
Aug. 29, 2019 (CN) 201910808183.2

(51) Int. Cl. C09J 7/25; B29C 59/02; C09J 7/40

(52) U.S. Cl. CPC C09J 7/25; B29C 59/022; C09J 7/405; B29C 2059/023; B29L 2007/008

(57) ABSTRACT

The disclosure provides a micro-groove drag reduction flexible film and a preparation method thereof. The micro-groove film has a triangular groove structure on the upper surface along the direction of an air flow, and an adhesive layer on the lower surface for quick adhesion to an aircraft surface. After the surface of the aircraft is covered with a micro-groove film, it could limit the spanwise movement of the bottom air at the boundary layer of the aircraft surface, improve the flow field characteristics of the aircraft near the wall, and effectively reduce the frictional resistance of the wall. The micro-groove flexible film is prepared by a roller hot pressing method. The triangular groove structure is processed on the surface of the mold roller of the double roller hot press. After pretreatment of the thermoplastic polyurethane (TPU) polymer film, a micro-groove structure is hot-pressed on the surface of the TPU film.

### CROSS REFERENCE TO RELATED APPLICATION

The present application claims the benefit and priority of Chinese Patent Application No. 201910808183.2 filed on Aug. 29, 2019, the disclosure of which is incorporated by reference herein in its entirety as part of the present application.

### TECHNICAL FIELD

The disclosure belongs to the field of flow control in fluid mechanics, and particularly to a micro-groove drag reduction flexible film and a preparation method thereof.

### BACKGROUND ART

In nature, sharks have a micro-raised armor structure on the skin, which can effectively reduce the resistance of sharks in the water. Inspired by nature, it is studied and found that a reasonable groove with a certain scale on the surface of an object can effectively reduce the friction resistance thereof. In order to travel at high speed in the air, the aircraft needs to overcome great air resistance, and the resistance is mainly composed of surface friction resistance and differential pressure resistance, of which the friction resistance accounts for a high portion. In view of the development of the aviation industry and the problems of energy shortage and environmental pollution, the research on reducing the resistance of the aircraft has become particularly urgent. Therefore, reducing the friction resistance between the aircraft and the air during travel is helpful to improve the speed and voyage of the aircraft, and can also effectively save energy and reduce carbon emissions. At present, scholars have conducted numerical simulation and experimental research on the effect and mechanism of drag reduction by arrangement of the groove structure on the surface of the object. 3M company in the United States has developed a groove film to provide research institutions with different specifications of drag reduction films for testing and experimental research; European Airbus has carried out an entire-machine flight test verification of the groove structure on A320 testing machine, and the results showed that the groove film could save 1%-2% of fuel.

### SUMMARY

An object of the present disclosure is to provide a micro-groove drag reduction flexible film and a preparation method thereof. The present disclosure makes it possible to form a flexible film that exhibits a certain drag reduction effect with high efficiency and large area.

The micro-groove drag reduction flexible film according to the present disclosure is composed of a TPU (thermoplastic polyurethane) polymer layer with a triangular micro-groove structure on the upper surface, an intermediate adhesive layer and a bottom release paper. The triangular groove structure is evenly distributed at equal intervals along the direction of air flow in the TPU polymer layer, and distributed in a sinusoidal function along the direction of air flow.

The method for preparing the micro-groove drag reduction flexible film according to the present disclosure comprises the following steps: calculating an actual size of the micro-groove structure according to the actual operating conditions of an aircraft; machining a hollow aluminum mold roller having a V-shaped groove structure on the surface by using a high-precision machine tool system according to the actual size of the micro-groove structure, cleaning the hollow aluminum mold roller, and installing on a double roller hot press; pretreating the TPU polymer film to be processed; setting the process parameters of the double roller hot press, and hot-pressing the surface of the TPU polymer film to form the micro-groove structure thereon. The specific technical solution is shown as follows:

Step one, the actual size of the micro-groove structure is determined. According to the actual operating conditions of the aircraft, the actual size of the micro-groove structure is determined at a dimensionless number

$${h}^{+} ( {h}^{+} = \frac{h \cdot {u}_{τ}}{υ} ,$$

where υ is an air kinematic viscosity) for a groove height h (a peak-to-valley depth of the micro-groove) to a turbulent friction velocity u_{τ}of 12-15. An inlet-air velocity of 30 m/s is taken as an example, under the condition that a characteristic length is 1 m, the groove structure has a peak-to-peak width s of 0.2 mm, the micro-groove structure has a peak-to-valley depth h of 0.17 mm, and the triangular groove has a vertex angle α of 60°, the groove structure has a amplitude of the sinusoidal function distribution along the flow direction of 1 mm, in which the sinusoidal function has a wavelength of 20 mm.

Step two, a mold roller for hot-pressing micro-groove structures is machined. According to the actual size of the micro-groove structure, the mold roller is machined by using a high-precision machine tool system for hot-pressing the TPU polymer film. and is cleaned with anhydrous ethanol, dried and coated with a release agent, and a heating rod is then passed through the center of the roller, and the resulting roller is installed on a double roller hot press.

Step three, the TPU polymer film is pretreated. The groove height is set to 0.2 mm. A TPU film with a thickness of 0.5 mm is cut to fit the feed size of the double roller hot press, and the surface thereof is then cleaned by using anhydrous ethanol to remove the stain, and the resulting TPU film is air-dried, and coated with an anti-adhesive agent.

Step four, the surface of the TPU polymer film is hot-pressed to form a micro-groove structure thereon. The double roller hot press is set to have the following working parameters: the mold roller has a temperature of 90-92 ° C., and a rotation speed of the lowest grade of 3 r/min; when the TPU polymer film is placed in the feed port, the contact pressure between the mold roller and the TPU polymer film is set at 83-85 N. After the temperature of the mold roller reaches the set temperature, the roller is turned on for rotation to hot-press the TPU polymer film to form the micro-groove structure thereon.

The micro-groove drag reduction flexible film and the preparation method thereof according to the present disclosure results in a film with a micro-groove structure that is curved distributed along the flow direction. After being pasted on the surface of an aircraft, the film could improve the flow field characteristics of the near-wall area of the aircraft, limit the spanwise movement of the bottom air of the boundary layer, and reduce the surface frictional resistance of the aircraft during travel. The micro-groove drag reduction flexible film according to the present disclosure has the advantages of simple process equipment, economy and practicability, and being easy to manufacture, and thus it is suitable for mass production and has good engineering application prospects.

### BRIEF DESCRIPTION OF THE DRAWINGS

In order to more clearly explain the technical solutions in the present disclosure or prior art, the following drawings needed in the description of the embodiments or prior art would be briefly introduced. Obviously, the drawings in the following description are only the embodiment of the present disclosure, and for those of ordinary skill in the art, other drawings could be obtained in accordance with the accompanying drawings provided herein without creative work.

FIG. 1 shows a schematic diagram of the composition of the micro-groove drag reduction flexible film, in which 1 refers to a surface layer of the TPU polymer film, 2 refers to an intermediate adhesive layer, and 3 refers to a bottom release paper;

FIG. 2 shows a schematic diagram of the triangular groove structure on the surface of the micro-groove drag reduction flexible film;

FIG. 3 shows a schematic diagram of the structure of a mold roller for a double roller hot press;

FIG. 4 shows a schematic diagram of the work of a double roller hot press, in which 4 refers to a mold roller, 5 refers to a mold roller heating tube, 6 refers to a rubber bottom shaft, and 7 refers to a TPU polymer film.

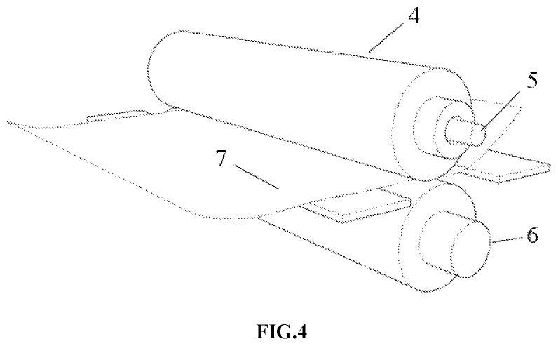

### DETAILED DESCRIPTION OF THE EMBODIMENTS

The technical solutions in the embodiments of the present disclosure will be clearly and completely described below in conjunction with the accompanying drawings in the embodiments of the present disclosure. Obviously, the described embodiments are only a part of the embodiments of the present disclosure, rather than all the embodiments. Based on the embodiments in this disclosure, all other embodiments obtained by those of ordinary skill in the art without creative work shall fall within the protection scope of this disclosure.

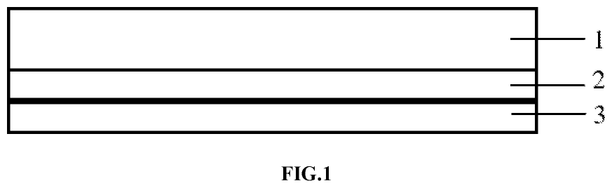

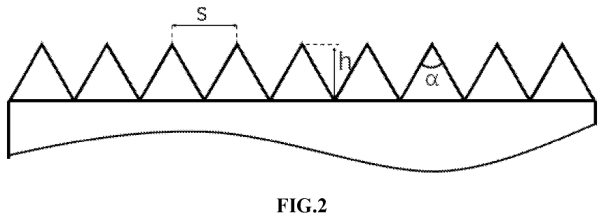

Step one, the micro-groove drag reduction flexible film is composed of a surface layer of a TPU polymer film, an adhesive layer and a bottom release paper, shown in FIG. 1, wherein the surface layer of the TPU polymer film has a triangular groove structure evenly distributed along the direction of air flow at equal intervals. According to the actual operating conditions of the aircraft, by taking an inlet-air velocity of 30 m/s and a characteristic length of 1 m as an example, the actual size of the micro-groove structure is determined. Under the condition that the dimensionless number

$${h}^{+} ( {h}^{+} = \frac{h \cdot {u}_{τ}}{υ} ,$$

where υ is an air kinematic viscosity) for a height of the micro-groove h (a peak-to-valley depth of the micro-groove) to a turbulent friction velocity υ_{τ}is 12-15, the groove has a peak-to-peak width s of 0.2 mm, the micro-groove has a peak-to-valley depth h of 0.17 mm, the triangular groove has a vertex angle a of 60°, and the groove structure has an amplitude of the sinusoidal function distribution along the flow direction of 1 mm, in which the wavelength of the sinusoidal function is 20 mm, shown in FIG. 2.

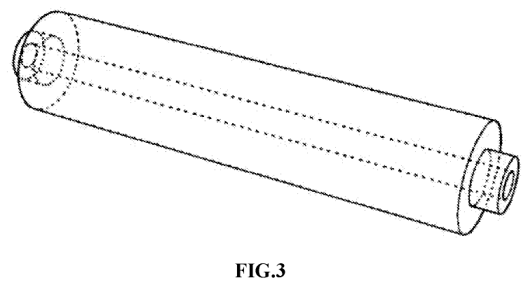

Step two, according to the actual size of the micro-groove structure obtained in step one, a micro-groove mold roller for hot pressing the TPU polymer film is machined by using a high-precision machine tool system, cleaned with anhydrous ethanol, dried and coated with a release agent, and a heating rod is then passed through the center of the roller, and the resulting roller is installed on a double roller hot press, shown in FIG. 3.

Step three, the groove height is set to 0.2 mm. A TPU film with a thickness of 0.5 mm is selected and cut to fit the feed size of the double roller hot press, the surface thereof is then cleaned by using anhydrous ethanol to remove the stain, and the resulting TPU film is air-dried and coated with an anti-adhesive agent.

Step four, the double roller hot press is set to have the following working parameters: the mold roller has a temperature of 90-92°C., and a rotation speed of 3 r/min; when the TPU polymer film is placed in the feed port, the contact pressure between the mold roller and TPU polymer film is set at 83-85 N. After the temperature of the mold roller reaches the set temperature, the roller is turned on for rotation, and the TPU polymer film enters into a hot pressing zone of the roller, and is hot-pressed to obtain the micro-groove structure on the surface.

The micro-groove drag reduction flexible film prepared according to the above method could achieve a local drag reduction effect of more than 8% under the experimental conditions of 30 m/s in the wind tunnel experiment. The micro-groove drag reduction flexible film could be pasted on the surface of the aircraft according to the actual flight conditions of the aircraft, without changing the shape and characteristics of the aircraft, and it could restrict the air spanwise movement in the area near the wall, effectively reduce wall friction, and improve the flight performance of the aircraft by means of the triangular micro-groove structure, thereby achieving the purpose of reducing the overall flight resistance, increasing the voyage of the aircraft, and reducing emissions.

The technical solutions provided by the present disclosure have been described in detail above. Specific examples are described herein to illustrate the principles and embodiments of the present disclosure, and the above embodiments are intended to help understand the method of the disclosure and core ideas thereof. It should be noted that for those skilled in the art, without departing from the principle of the present disclosure, several improvements and modifications could be made to the present disclosure, and these improvements and modifications also fall within the protection scope of the claims of the present disclosure.

What is claimed is:

1. A micro-groove drag reduction flexible film, comprising:
a TPU polymer layer with a triangular micro-groove structure on the surface;
an intermediate adhesive layer; and
a bottom release paper;
wherein the triangular micro-groove structure is evenly distributed at equal intervals along the direction of air flow in the TPU polymer layer, and distributed in a sinusoidal function along the direction of air flow;
wherein the micro-groove drag reduction flexible film is prepared by a method comprising the steps of:
calculating an actual size of the micro-groove structure according to the actual operating conditions of an aircraft and based on a dimensionless number for a height of the micro-groove to a turbulent friction velocity of 12-15;
machining a hollow aluminum mold roller having a V-shaped groove structure on the surface according to the actual size of the micro-groove structure by using a high-precision machine tool system for hot pressing of the TPU polymer film; cleaning the mold roller obtained in the step two by using anhydrous ethanol, drying and coating with a release agent, and installing the mold roller on a double roller hot press;
pretreating the TPU polymer film to be processed: cutting the TPU polymer film to fit the size of the roller in the double roller hot press, cleaning the surface by using anhydrous ethanol, air-drying and coating with an anti-sticking; and
hot-pressing the surface of the TPU polymer film to form a micro-groove structure thereon: setting working parameters of the double roller hot press, wherein the working parameters comprise the temperature, the rotation speed and the pressure of the mold roller; after the temperature of the mold roller reaches the set temperature of the mold roller, turning on the roller for rotation, and adding the TPU polymer film thereto, and hot-pressing the TPU polymer film to obtain the micro-groove drag reduction flexible film with a triangular micro-groove structure on the surface.

2. The micro-groove drag reduction flexible film of claim 1, wherein the actual size of the micro-groove structure is calculated according to formula 1:
$${h}^{+} = \frac{h \cdot {u}_{τ}}{υ} ; \qquad formula 1$$
where,
h⁺refers to a dimensionless number for a height of the micro-groove to a turbulent friction velocity;
h refers to the height of the micro-groove, expressed in m;
u_{τ}refers to the turbulent friction velocity, expressed in m/s; and
υ refers to an air kinematic viscosity, expressed in m²/s.

3. The micro-groove drag reduction flexible film of claim 1, wherein
the triangular micro-groove structure comprises a peak-to-peak width s of 0.1 mm-0.8 mm, a peak-to-valley depth h of 0.1 mm-0.8 mm;
wherein the triangular groove structure comprises a vertex angle α of 60°; and
the groove structure comprises an amplitude of the sinusoidal function distribution along the flow direction of 1 mm, in which the wavelength of the sinusoidal function is 20 mm.

4. The micro-groove drag reduction flexible film of claim 1, wherein the TPU polymer film has a thickness of 0.3 mm-1 mm.

5. The micro-groove drag reduction flexible film of claim 1, wherein the micro-groove has a height of 0.2 mm, and the TPU polymer film has a thickness of 0.5 mm.

6. The micro-groove drag reduction flexible film of claim 1, wherein under the condition that the temperature of the mold roller of the double roller hot press is 90-92 ° C., the contact pressure between the mold roller and the TPU polymer film is set at 83-85 N.

7. The micro-groove drag reduction flexible film of claim 1, wherein the roller has a rotation speed of 3 r/min.

8. The micro-groove drag reduction flexible film of claim 6, wherein the roller has a rotation speed of 3 r/min.
